(19) United States
(12) Patent Application Publication
(10) Pub. No.: US 2013/0030331 A1
(43) Pub. Date: Jan. 31, 2013

(54) METHOD AND SYSTEM FOR APPLICATION OF THERMAL THERAPY RELATIVE TO THE TREATMENT OF DEEP-VEIN THROMBOSIS AND LYMPHEDEMA

(71) Applicants: Tony Quisenberry, Highland Village, TX (US); Sam K. McSpadden, Austin, TX (US)

(72) Inventors: Tony Quisenberry, Highland Village, TX (US); Sam K. McSpadden, Austin, TX (US)

(21) Appl. No.: 13/558,615

(22) Filed: Jul. 26, 2012

Related U.S. Application Data
(60) Provisional application No. 61/512,305, filed on Jul. 27, 2011.

(51) Int. Cl. A61H 1/00; A61H 9/00

(52) U.S. Cl. 601/18

(57) ABSTRACT

In one aspect, the present invention relates to a therapy system. The therapy system includes a control unit and a therapy cuff. The therapy cuff is constructed to be wrapped around an appendage of a patient. The therapy cuff includes a resistive-heating element electrically coupled to the control unit and a compression bladder fluidly coupled to the control unit via a tube. The compression bladder is disposed outwardly of the resistive-heating element. A first compression chamber and a second compression chamber are formed in the compression bladder. The resistive-heating element dilates a plurality of vessels within the appendage facilitating removal of accumulated fluid from the appendage.

### CROSS-REFERENCE TO RELATED APPLICATIONS

This application claims priority to, and incorporates by reference for any purpose the entire disclosure of, U.S. Provisional Patent Application No. 61/512,305 filed on Jul. 27, 2011. U.S. patent application Ser. No. 11/733,709, filed Apr. 10, 2007, U.S. patent application Ser. No. 12/234,394, filed Sep. 19, 2008, and U.S. patent application Ser. No. 12/708,422, filed Feb. 18, 2010 are each incorporated herein by reference.

### BACKGROUND

1. Field of the Invention

The present invention relates to methods and systems for treating medical conditions, and more particularly, but not by way of limitation, to methods and systems for treating deep-vein thrombosis or lymphedema utilizing a combination of thermal and compression therapy.

2. History of the Related Art

Considerable medical attention has been given to a serious medical issue of deep-vein thrombosis (“DVT”). One approach to preventing DVT is external pneumatic compressions (“EPC”). EPC has been shown to be helpful as a prophylaxis for DVT, although refinements over existing systems are still in need. For example, multiple articles have been written addressing this issue, including a compilation of recommendations for preventing DVT (Heit J A: Current Recommendations for Prevention of Deep Venous Thrombosis. In: Handbook of Venous Disorders. Gloviczki P, Yao J S, eds. Cambridge, The University Press, 1996). Engineering studies are presented which also address EPC as a preventative for DVT (Kamm R D: Bioengineering Studies of Periodic External Compression as Prophylaxis Against Deep Vein Thrombosis—Part 1: Numerical Studies. J Biomech Engineering 104(1): 87-95, 1982). Such efforts are meritorious for patient health due to possible Pulmonary Embolism (“PE”) resulting from DVT (National Institutes of Health Consensus Development Conference Statement: Prevention of Venous Thrombosis and Pulmonary Embolism. JAMA 6(2) 744-749, 1986). Additionally, studies have been performed relative to DVT and orthopedic surgery (“OS”) (Westrich G H, Sculco T P: Prophylaxis Against Deep Vein Thrombosis After Total Knee Arthroplasty. J Bone Joint Surg 78-A(6): 826-834, 1996).

### SUMMARY

The present invention relates to methods and systems for treating conditions such as, for example, deep-vein thrombosis or lymphedema and more particularly, but not by way of limitation, to methods and systems for treating deep-vein thrombosis or lymphedema utilizing a combination of thermal and compression therapy. In one aspect, the present invention relates to a therapy system. The therapy system includes a control unit and a therapy cuff. The therapy cuff is constructed to be wrapped around an appendage of a patient. The therapy cuff includes a resistive-heating element electrically coupled to the control unit and a compression bladder fluidly coupled to the control unit via a tube. The compression bladder is disposed outwardly of the resistive-heating element. A first compression chamber and a second compression chamber are formed in the compression bladder. The resistive-heating element dilates a plurality of vessels within the appendage facilitating removal of accumulated fluid from the appendage.

In another aspect, the present invention relates to a therapy system. The therapy system includes a control unit and a therapy cuff. The therapy cuff is constructed to be wrapped around an appendage of a patient. The therapy cuff includes a thermal element coupled to the control unit and a compression bladder disposed outwardly of the thermal element. A first compression chamber, a second compression chamber, and a third compression chamber are formed in the compression bladder. A first tube couples the first compression chamber to the control unit. A second tube couples the second compression chamber to the control unit. A third tube couples the third compression chamber to the control unit. The thermal element dilates a plurality of vessels within the appendage facilitating removal of accumulated fluid from the appendage.

In another aspect, the present invention relates to a method of treatment. The method includes securing a therapy cuff about an appendage of a patient, applying thermal therapy to the appendage, and dilating, via the thermal therapy, at least one vessel within the appendage. The method further includes inflating a compression bladder within the therapy cuff with a compressed fluid. The compression bladder includes a first compression chamber, a second compression chamber adjacent to the first compression chamber, and a third compression chamber adjacent to the second compression chamber. The dilating facilitates removal of accumulated fluid from the appendage.

### BRIEF DESCRIPTION OF THE DRAWINGS

A more complete understanding of the method and system of the present invention may be obtained by reference to the following Detailed Description when taken in conjunction with the accompanying drawings wherein:

FIG. 1A is a block diagram of a treatment system according to an exemplary embodiment;

FIG. 1B is a block diagram of a treatment system utilizing compression bladder having multiple chambers according to an exemplary embodiment;

FIG. 2A is a cross-sectional view, taken across line A-A of FIG. 1A, of a therapy cuff taken across line A-A according to an exemplary embodiment;

FIG. 2B is an interior view of a first bladder of the therapy cuff of FIG. 2A according to an exemplary embodiment;

FIG. 2C is a cross-sectional view, taken across line B-B of FIG. 1B, of a therapy cuff with multiple compression chambers according to an exemplary embodiment;

FIG. 2D is an interior view of a first bladder of the therapy cuff of FIG. 2C according to an exemplary embodiment;

FIG. 3 is a flow diagram illustrating a process for providing treatment for deep-vein thrombosis or lymphedema according to an exemplary embodiment;

FIG. 4A is a block diagram of a treatment system utilizing a resistive-heating element according to an exemplary embodiment;

FIG. 4B is a block diagram of a treatment system utilizing a resistive-heating element and a compression bladder having multiple compression chambers according to an exemplary embodiment;

FIG. 5A is a cross-sectional view, taken across line C-C of FIG. 4A, of a therapy cuff with a resistive-heating element according to an exemplary embodiment;

FIG. 5B is an interior view illustrating an arrangement of the resistive-heating element of the therapy cuff of FIG. 5A according to an exemplary embodiment;

FIG. 5C is a cross-sectional view of a therapy cuff, taken across line D-D of FIG. 4B, with multiple compression chambers and a resistive-heating element according to an exemplary embodiment;

FIG. 5D is an interior view illustrating an arrangement of the resistive-heating element of the therapy cuff of FIG. 5C according to an exemplary embodiment;

FIG. 6 is a flow diagram illustrating a process utilizing a resistive-heating element for providing treatment for deep-vein thrombosis or lymphedema according to an exemplary embodiment;

FIG. 7 is a block diagram of a treatment system utilizing a single fluid for compression and thermal therapy according to an exemplary embodiment;

FIG. 8 is a cross-sectional view of a therapy cuff utilizing a single fluid for compression and thermal therapy according to an exemplary embodiment;

FIG. 9 is a flow diagram illustrating a process for providing treatment for deep-vein thrombosis or lymphedema according to an exemplary embodiment;

FIG. 10 is a side view of a therapy cuff according to an exemplary embodiment; and

FIG. 11 is a plan view of an interior portion of the therapy cuff of FIG. 10 according to an exemplary embodiment.

### DETAILED DESCRIPTION

Various embodiments of the present invention will now be described more fully with reference to the accompanying drawings. The invention may, however, be embodied in many different forms and should not be construed as limited to the embodiments set forth herein.

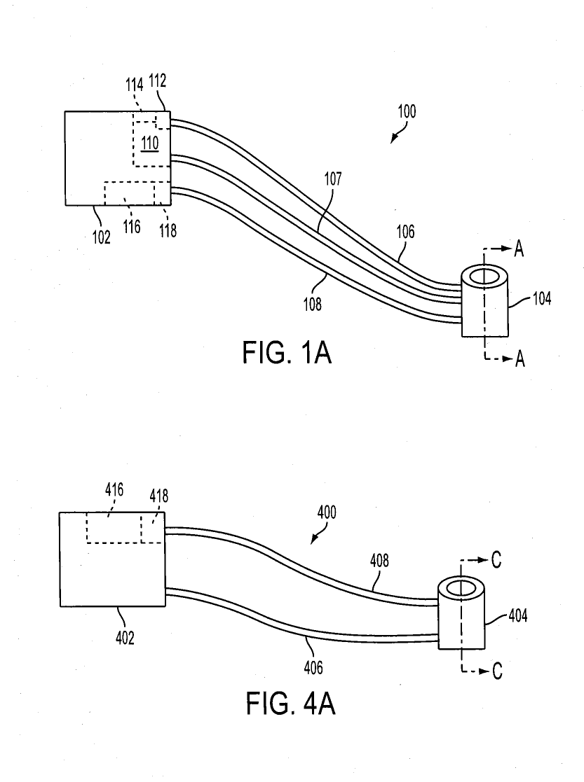

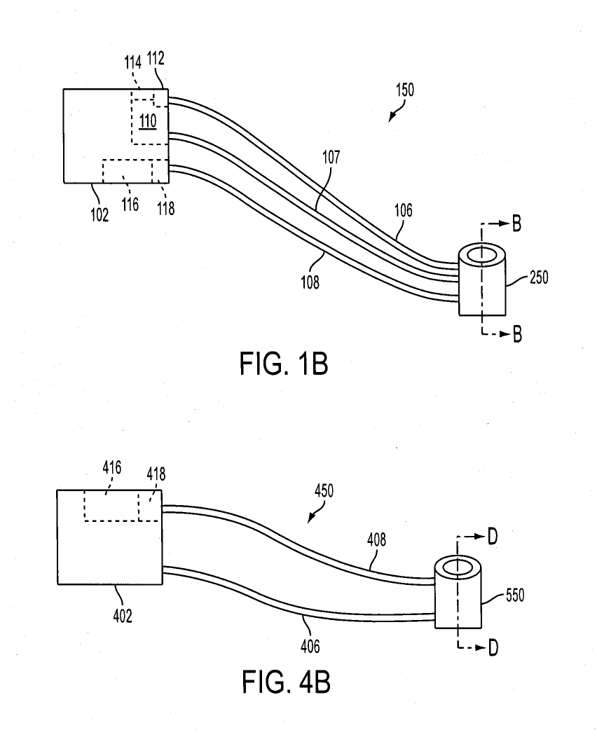

FIG. 1A is a block diagram of a treatment system according to an exemplary embodiment. A treatment system 100 includes a control unit 102 and a therapy cuff 104 fluidly coupled to the control unit 102 via a first thermal-fluid conduit 106, a second thermal-fluid conduit 107, and a compression-fluid conduit 108. The control unit 102 contains a thermal-fluid reservoir 110, a first pump 112, and a thermal element 114. The control unit 102 further includes a compression-fluid source 116 and a second pump 118. In a typical embodiment, the thermal element 114 may be, for example, a thermoelectric element, a resistive heating element, or any other appropriate device. The compression-fluid source 116 may be, for example, atmospheric air; however, in other embodiments, the compression-fluid source 116 may be, for example, an external pressurized vessel containing a gas such as, for example, oxygen, air, or other appropriate fluid. In other embodiments, the compression-fluid source 116 may be, for example, a hospital oxygen supply.

FIG. 1B is a block diagram of a treatment system utilizing a multi-chamber compression bladder according to an exemplary embodiment. A treatment system 150 includes the control unit 102 and a therapy cuff 250 fluidly coupled to the control unit 102 via the first thermal-fluid conduit 106, the second thermal-fluid conduit 107, and the compression-fluid conduit 108.

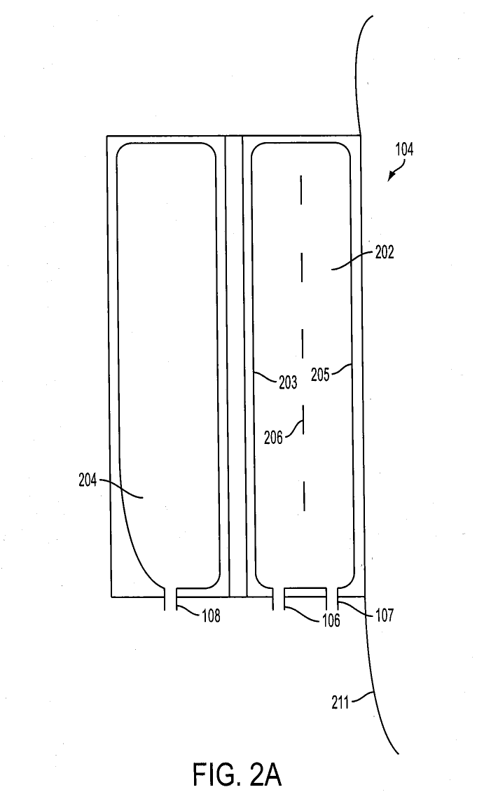

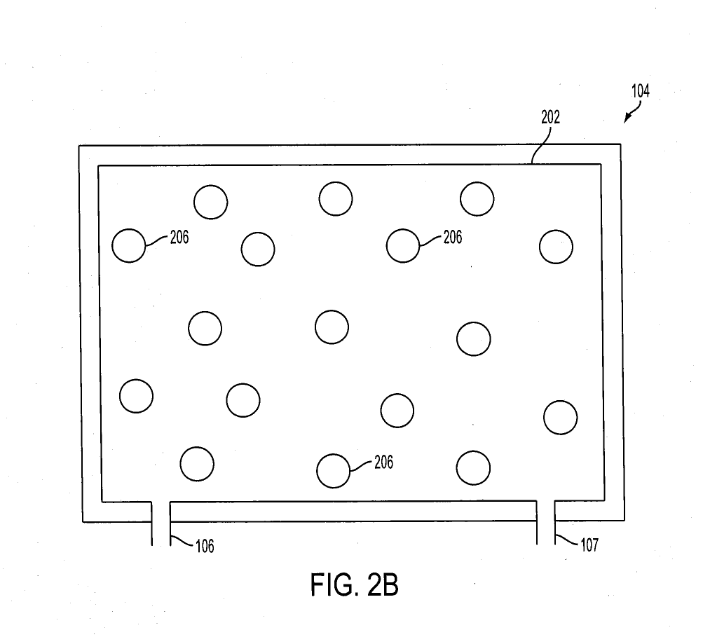

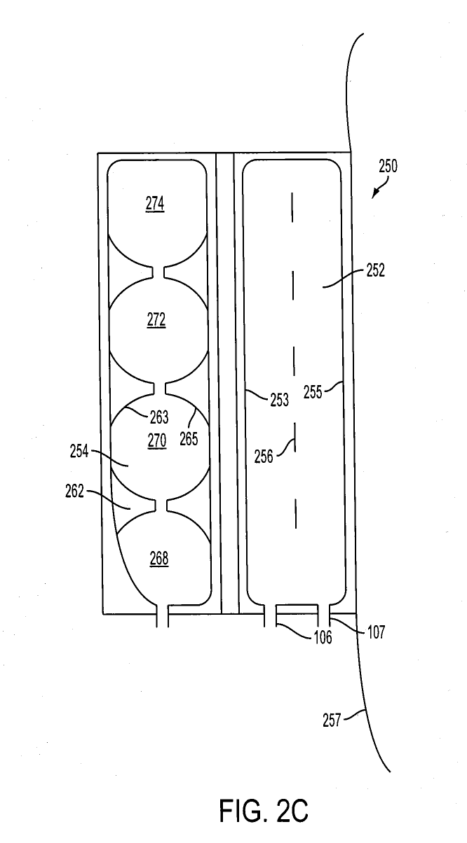

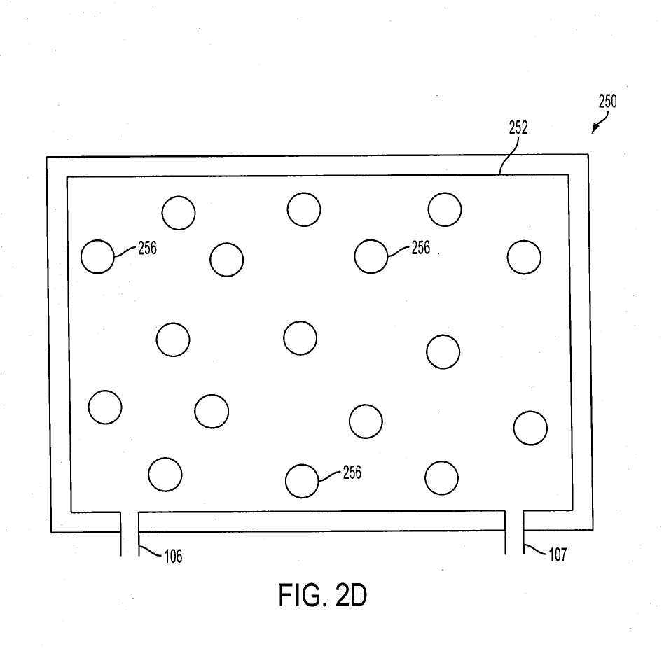

FIG. 2A is a cross-sectional view taken across line A-A of FIG. 1A, of a therapy cuff according to an exemplary embodiment. FIG. 2B is an interior view of a first bladder of the therapy cuff of FIG. 2A. Referring to FIGS. 2A and 2B, the therapy cuff 104 includes a first bladder 202 and a second bladder 204. The first bladder 202 is positioned adjacent to a bodily appendage 211 of a patient. The second bladder 204 is positioned outwardly of the first bladder 202. The first bladder 202 is fluidly coupled to the thermal-fluid reservoir 110 (shown in FIG. 1A) via the first thermal-fluid conduit 106 and the second thermal-fluid conduit 107. At least one weld 206 joins a first surface 203 of the first bladder 202 and a second surface 205 of the first bladder 202 thereby creating a generally serpentine flow path for thermal fluid. As shown in FIG. 2B, the at least one weld 206 is generally circular in shape; however, one skilled in the art will recognize that other arrangements could be utilized. In a typical embodiment, the therapy cuff 104 is wrapped around a circumference of the bodily appendage 211 such as, for example, an ankle, a foot, an arm, or a leg of a patient.

Still referring to FIG. 2A-2B, the second bladder 204 is fluidly coupled to the compression-fluid source 116 (shown in FIG. 1A) via the compression-fluid conduit 108 and is joined to an outer surface of the first bladder 202. The second bladder receives compressed fluid from the compression-fluid source 116. Inflation of the second bladder 204 imparts compression to the bodily appendage 211. In a typical embodiment, a frequency and an intensity of compression may be varied via, for example, the control unit 102. In an exemplary embodiment, the second bladder 204 exerts pressure in the range of approximately 15 mmHg to approximately 120 mmHg; however, in other embodiments, different pressures may be applied.

Referring to FIGS. 1A and 2A-2B, during operation, the therapy cuff 104 is secured around the bodily appendage 211. In a typical embodiment, the therapy cuff 104 is secured about a distal portion of the bodily appendage 211 such as, for example, an ankle or a foot region of the patient. The second pump 118 compresses a fluid from the compression-fluid source 116. Compressed fluid is transmitted to the second bladder 204 via the compression-fluid conduit 108. As the second bladder 204 fills with the compressed fluid, generally uniform pressure is exerted against the bodily appendage 211. In an exemplary embodiment, the second bladder 204 exerts pressure in the range of approximately 15 mmHg to approximately 120 mmHg; however, in other embodiments, different pressures may be applied.

Still referring to FIGS. 1A and 2A-2B, the thermal element 114 warms a thermal fluid contained within the thermal-fluid reservoir 110. The first pump 112 transmits thermal fluid to the first bladder 202 of the therapy cuff 104 via the first thermal-fluid conduit 106. Thermal fluid enters the first bladder 202, passes through the serpentine flow path created by the at least one weld 206, and provides thermal therapy to the bodily appendage 211. The thermal fluid then exits the first bladder 202 and returns to the thermal-fluid reservoir 110 via the second thermal-fluid conduit 107. In a typical embodiment, the thermal element 114 may be, for example, a thermoelectric element, a resistive element, or any other appropriate device. In a typical embodiment, the thermal element 114 is utilized to cool the thermal fluid. In other embodiments, contrast thermal therapy, utilizing timed intervals of heating and cooling, may be applied to the patient. In a typical embodiment, thermal therapy occurs simultaneously with compression; however, one skilled in the art will recognize that thermal therapy and compression therapy may occur in any order. In an exemplary embodiment, thermal fluid within the first bladder 202 is warmed to a temperature of approximately 110° F. or less; however, in other embodiments, other temperatures may be applied.

FIG. 2C is a cross-sectional view, taken across line B-B of FIG. 1B, of a therapy cuff including multiple compression chambers according to an exemplary embodiment. FIG. 2D is an interior view of a first bladder of the therapy cuff of FIG. 2C. Referring now to FIGS. 2C and 2D, a therapy cuff 250 includes a first bladder 252 and a second bladder 254. The first bladder 252 is positioned adjacent to a bodily appendage 257 of a patient. The second bladder 254 is positioned outwardly of the first bladder 252. The first bladder 252 is fluidly coupled to the thermal-fluid reservoir 110 (shown in FIG. 1B) via the first thermal-fluid conduit 106 and the second thermal-fluid conduit 107. At least one weld 256 joins a first surface 253 of the first bladder 252 and a second surface 255 of the first bladder 252 thereby creating a generally serpentine flow path for thermal fluid. As shown in FIG. 2D, the at least one weld 256 is generally circular in shape; however, one skilled in the art will recognize that other arrangements could be utilized. The therapy cuff 250 is wrapped around a circumference of the bodily appendage 257 such as, for example, an arm or leg of a patient.

Still referring to FIG. 2C, the second bladder 254 is fluidly coupled to the compression-fluid source 116 (shown in FIG. 1B) via the compression-fluid conduit 108 and is joined to the first surface 253 surface of the first bladder 252. A plurality of welds 262 join a first surface 263 of the second bladder 254 and a second surface 265 of the second bladder 254 thereby creating a series of compression chambers within the second bladder 254 such as, for example compression chambers 268, 270, 272, 274. The compression chamber 268 is fluidly coupled to the compression chamber 270. The compression chamber 270 is fluidly coupled to the compression chamber 272. The compression chamber 272 is fluidly coupled to the compression chamber 274. The compression chambers 268, 270, 272, 274 inflate in sequence causing a compression gradient to be applied to the bodily appendage 257. Such a compression gradient is particularly useful in treatment of, for example, lymphedema. Although the therapy cuff 250 has been described herein as including the compression chambers 268, 270, 272, 274, therapy cuffs utilizing principles of the invention may include any number of compression chambers.

Referring to FIGS. 1B and 2C-2D, during operation, the therapy cuff 250 is secured about the bodily appendage 257. Compressed fluid from the compression-fluid source 116 fills the plurality of compression chambers 268, 270, 272, 274 in sequence. The plurality of welds 262 prevent the second bladder 254 from inflating uniformly and cause the compression chambers 268, 270, 272, 274 to inflate in sequence. For example, the compression chamber 268 substantially inflates before the compression chamber 270. Likewise, the compression chamber 270 substantially inflates before the compression chamber 272. Thus, a compression gradient is applied to the bodily appendage 257. Such a compression gradient drives accumulated fluid from the bodily appendage 257 and is effective in treatment of, for example, lymphedema. In other embodiments, the compression chambers 268, 270, 272, 274 are not fluidly coupled to each other. Rather, the compression chambers 268, 270, 272, 274 are each fluidly connected to the compression-fluid source 116 independent of each other. In such an arrangement, a different pressure may be applied to each of the compression chambers 268, 270, 272, 274. Further, a pattern of compression may be varied between the compression chambers 268, 270, 272, 274. In an exemplary embodiment, the second bladder 254 exerts pressure in the range of approximately 15 mmHg to approximately 120 mmHg; however, in other embodiments, different pressures may be utilized. In a typical embodiment, a frequency and an intensity of compression may be varied via, for example, the control unit 102.

Still referring to FIGS. 1B and 2C-2D, the thermal element 114 warms thermal fluid contained within the thermal-fluid reservoir 110. The first pump 112 transmits thermal fluid to the first bladder 252 of the therapy cuff 250 via the first thermal-fluid conduit 106. Thermal fluid enters the first bladder 252, passes through the serpentine flow path created by the at least one weld 206, and provides thermal therapy to the bodily appendage 257. The thermal fluid exits the first bladder 252 and returns to the thermal-fluid reservoir 110 via the second thermal-fluid conduit 107. In a typical embodiment, the thermal element 114 may be utilized to cool thermal fluid. In other embodiments, contrast thermal therapy, utilizing timed intervals of heating and cooling, may be utilized. In a typical embodiment, thermal therapy occurs simultaneously with compression; however, one skilled in the art will recognize that thermal therapy and compression therapy may occur in any order. In an exemplary embodiment, the thermal fluid within the first bladder 252 is warmed to a temperature of approximately 110° F. or less; however, in other embodiments, other temperatures may be utilized.

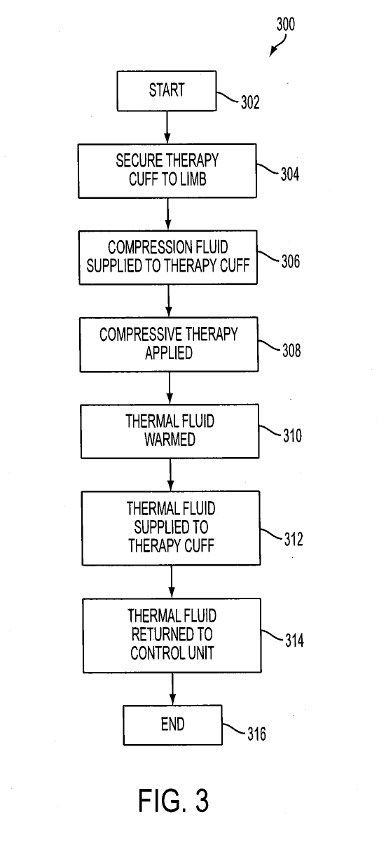

FIG. 3 is a flow diagram illustrating a process for providing treatment for deep-vein thrombosis or lymphedema according to an exemplary embodiment. A process 300 begins at step 302. At step 304, the therapy cuff 104, 250 is secured about the bodily appendage 211. At step 306, the control unit 102 directs the second pump 118 to pump compression fluid supplied by the compression-fluid source 116 through the compression-fluid conduit 108 into the second bladder 204, 254 of the therapy cuff 104, 250. At step 308, compressive therapy is applied to the bodily appendage 211, 257. At step 310, the control unit 102 directs the thermal element 114 to warm thermal fluid. At step 312, thermal fluid is circulated through the first thermal-fluid conduit 106 into the first bladder 202, 252 thereby applying thermal therapy to the bodily appendage 211, 257. Application of thermal therapy, particularly application of temperatures higher than the patient's body temperature, causes dilation of, for example, blood vessels thereby facilitating movement of accumulated fluid from the bodily appendage 211, 257. In other embodiments, steps 310 and 312 may include cooling the thermal fluid or applying contrast thermal therapy. At step 314, the thermal fluid is returned from the first bladder 202, 252 to the control unit 102 via the second thermal-fluid conduit 107. The process 300 ends at step 316. Although, the process 300 has been described above as utilizing the therapy cuff 104, one skilled in the art will recognize that, in other embodiments, the process 300 may utilize the therapy cuff 250. In various embodiments, steps 306 through 314 may be performed in any order.

FIG. 4A is a block diagram of a treatment system utilizing a resistive heating element according to an exemplary embodiment. A treatment system 400 includes a control unit 402 and a therapy cuff 404 fluidly coupled to the control unit 402 via an electrical connection 406 and a compression-fluid conduit 408. The control unit 402 includes a compression-fluid source 416 and a pump 418. The compression-fluid source 416 may be, for example, atmospheric air; however, in other embodiments, the compression-fluid source 416 may be, for example, an external pressurized vessel containing a gas such as, for example, oxygen, air, or other appropriate gas. In other embodiments, the compression-fluid source 416 may be, for example, a hospital oxygen supply. In a typical embodiment, the electrical connection 406 is a wire; however, in other embodiments other types of connections could be utilized such as, for example, a wireless connection.

FIG. 4B is a block diagram of a treatment system utilizing a resistive-heating element and a multi-chamber compression bladder according to an exemplary embodiment. A treatment system 450 includes the control unit 402 and a therapy cuff 550 fluidly coupled to the control unit 402 via the electrical connection 406 and the compression-fluid conduit 408. The control unit 402 includes the compression-fluid source 416 and the pump 418.

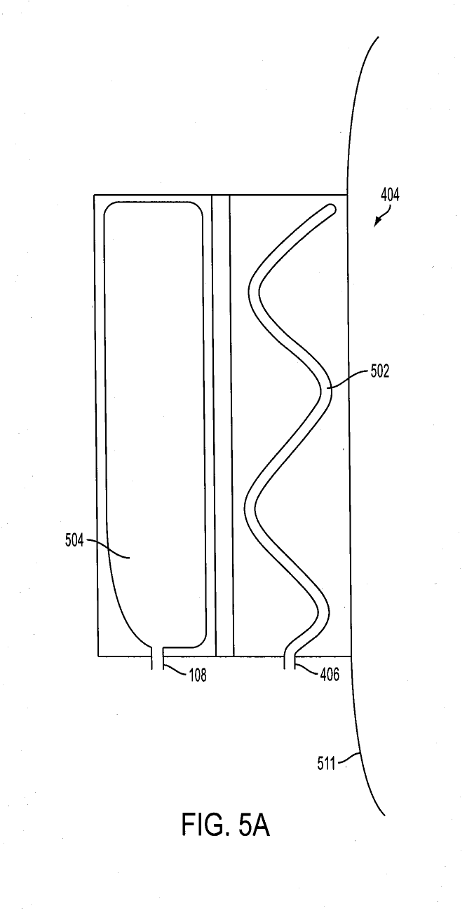

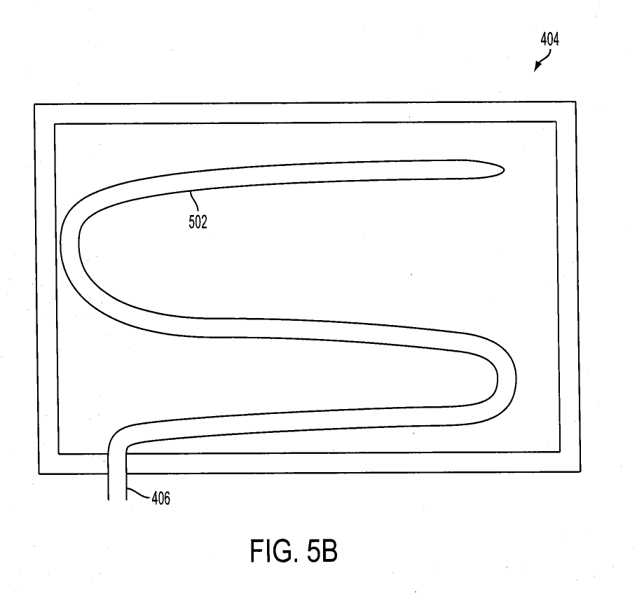

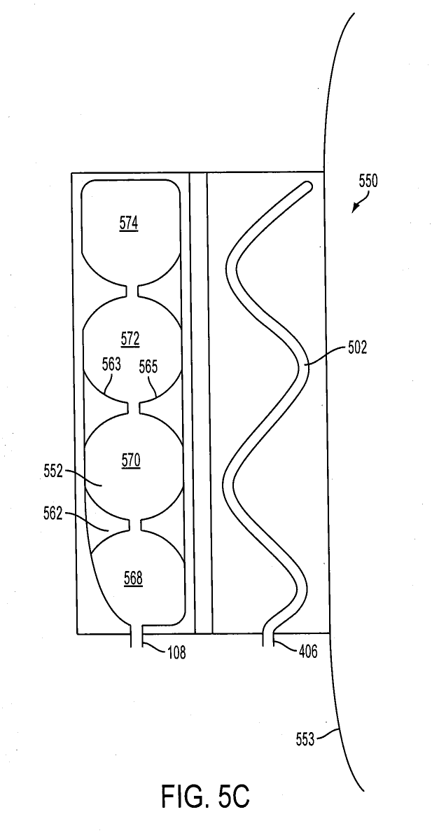

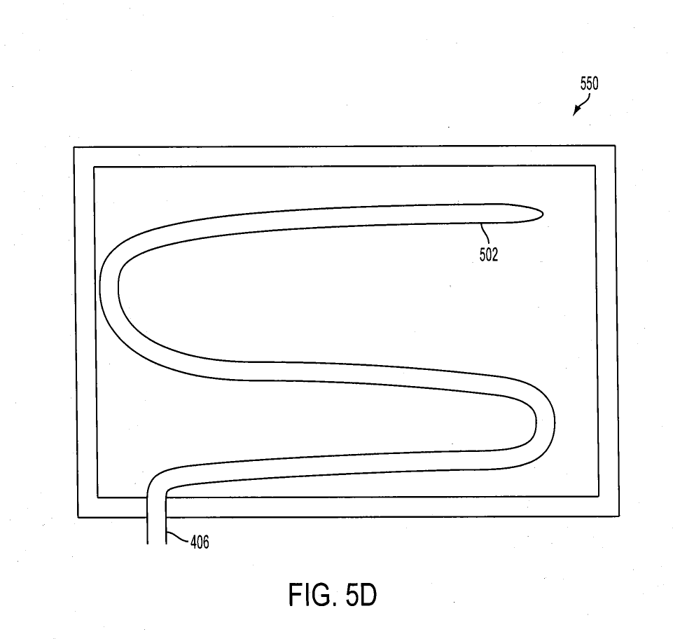

FIG. 5A is a cross-sectional view, taken across line C-C of FIG. 4A, of a therapy cuff with a resistive-heating element according to an exemplary embodiment. FIG. 5B is an interior view illustrating an arrangement of the resistive-heating element of the therapy cuff of FIG. 5A. Referring to FIGS. 5A and 5B, the therapy cuff 404 includes a resistive-heating element 502 and a bladder 504. The resistive-heating element 502 is positioned adjacent to a bodily appendage 511 of a patient. As shown in FIG. 5B, the resistive-heating element 502 is arranged in a generally serpentine pattern; however, in other embodiments, other arrangements could be utilized. The bladder 504 is positioned outwardly of the resistive-heating element 502. The resistive-heating element 502 is electrically connected to the control unit 402 (shown in FIG. 4A) via the electrical connection 406. The control unit 402 applies an electric current to the resistive-heating element 502 via the electrical connection 406. The electric current causes the resistive-heating element 502 to be, for example, warmed and thereby applies thermal therapy to the bodily appendage 511 such as, for example, an arm or leg of a patient. In an exemplary embodiment, the resistive-heating element 502 is warmed to a temperature of approximately 110° F. or less; however, in other embodiments, other temperatures may be utilized.

Referring now to FIGS. 4A and 5A-5B, the bladder 504 is fluidly coupled to the compression-fluid source 416 via the compression-fluid conduit 408 and is disposed outwardly of the resistive-heating element 502. The bladder 504 receives compressed fluid from the compression-fluid source 416. Inflation of the bladder 504 imparts compression to the bodily appendage 511 and is useful in treatment of, for example, deep-vein thrombosis. In a typical embodiment, a frequency and an intensity of compression may be varied via, for example, the control unit 102. In an exemplary embodiment, the bladder 504 exerts pressure in the range of approximately 15 mmHg to approximately 120 mmHg; however, in other embodiments, different pressures may be utilized.

FIG. 5C is a cross-sectional view, taken across line D-D of FIG. 4B, of a therapy cuff with multiple compression chambers and a resistive heating element according to an exemplary embodiment. FIG. 5D is an interior view illustrating an arrangement of the resistive-heating element of the therapy cuff of FIG. 5C. Referring to FIGS. 5C and 5D, a therapy cuff 550 includes the resistive-heating element 502 and a bladder 552. The resistive-heating element 502 is positioned adjacent to a bodily appendage 553 of a patient. As shown in FIG. 5D, the resistive-heating element 502 is arranged in a generally serpentine pattern; however, in other embodiments, other arrangements could be utilized. The bladder 552 is positioned outwardly of the resistive-heating element 502. The resistive-heating element 502 is electrically connected to the control unit 402 (shown in FIG. 4B) via the electrical connection 406. In a typical embodiment, the control unit 402 applies an electric current to the resistive-heating element 502 via the electrical connection 406. The electric current warms the resistive-heating element 502 and thereby applies thermal therapy to the bodily appendage 553 such as, for example, an arm or leg of the patient.

Referring now to FIGS. 4B and 5C-5D, the bladder 552 is fluidly coupled to the compression-fluid source 416 via the compression-fluid conduit 408 and is disposed outwardly of the resistive-heating element 502. A plurality of welds 562 join a first surface 563 of the bladder 552 and a second surface 565 of the bladder 552 thereby creating a series of compression chambers such as, for example, compression chambers 568, 570, 572, 574. The compression chamber 568 is fluidly coupled to the compression chamber 570. The compression chamber 570 is fluidly coupled to the compression chamber 572. The compression chamber 572 is fluidly coupled to the compression chamber 574. The compression chambers 568, 570, 572, 574 inflate in sequence to cause a compression gradient to be applied to the bodily appendage 553. Such gradient compression is particularly useful in treatment of, for example, lymphedema. Although the therapy cuff 550 has been described herein as including the compression chambers 568, 570, 572, 574, therapy cuffs utilizing principles of the invention may include any number of compression chambers. In other embodiments, the compression chambers 568, 570, 572, 574 are not fluidly coupled to each other. Rather, the compression chambers 568, 570, 572, 574 are fluidly connected to the compression-fluid source 416 independent of each other. In such an arrangement, a different pressure may be applied to each of the compression chambers 568, 570, 572, 574. Further, a pattern of compression may be varied between the compression chambers 568, 570, 572, 574. In an exemplary embodiment, the bladder 552 exerts pressure in the range of approximately 15 mmHg to approximately 120 mmHg; however, in other embodiments, different pressures may be applied.

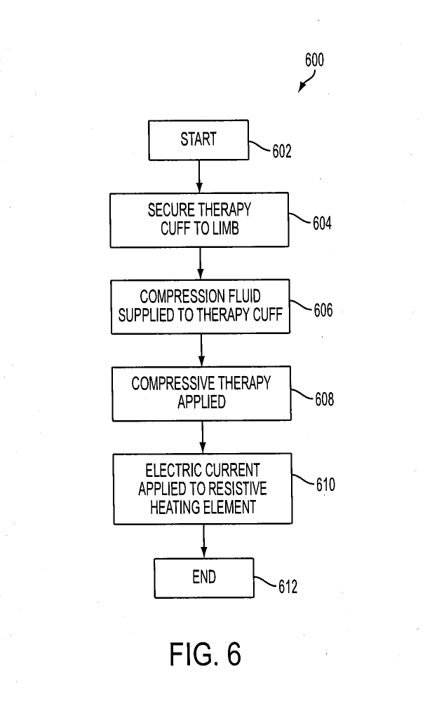

FIG. 6 is a flow diagram illustrating a process for utilizing a resistive-heating element to provide treatment for deep-vein thrombosis or lymphedema according to an exemplary embodiment. A process 600 begins at step 602. At step 604, the therapy cuff 404 is secured about the bodily appendage 511. At step 606, the control unit 402 directs the pump 418 to pump compression fluid supplied by the compression-fluid source 416 through the compression-fluid conduit 408 into the bladder 504, 552 of the therapy cuff 404, 550. At step 608, compressive therapy is applied to the bodily appendage 511, 553 of the patient. At step 610, the control unit 402 applies an electric current to the electrical connection 406 and the resistive-heating element 502 thereby applying thermal therapy to the bodily appendage 511, 553. Application of thermal therapy, particularly application of temperatures higher than the patient's body temperature, causes dilation of blood vessels thereby facilitating movement of accumulated fluid from the appendage. The process 600 ends at step 612. Although, the process 600 has been described above as utilizing the therapy cuff 404, one skilled in the art will recognize that, in other embodiments, the process 600 may utilize the therapy cuff 550. In various embodiments, steps 606-610 may be performed in any order.

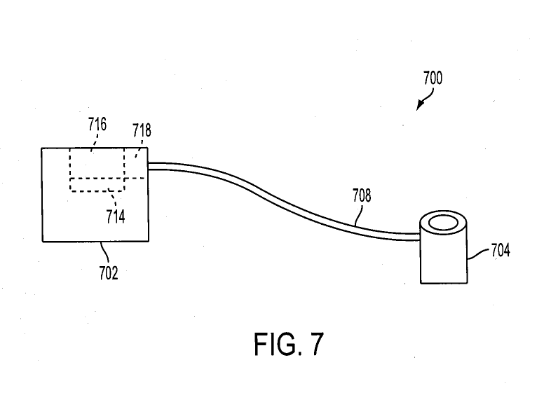

FIG. 7 is a block diagram of a treatment system utilizing a single fluid for compression and thermal therapy according to an exemplary embodiment. A treatment system 700 includes a control unit 702 and a therapy cuff 704 fluidly coupled to the control unit 702 via a conduit 708. The control unit 702 includes a fluid source 716 and a pump 718. A thermal element 714 is disposed within the control unit 702 and is thermally exposed to the fluid source 716. In a typical embodiment, the thermal element 714 may be, for example, a thermoelectric element, a resistive heating element, or any other appropriate device. The fluid source 716 may be, for example, atmospheric air; however, in various alternative embodiments, the fluid source 716 could be an external pressurized container of, for example, oxygen, air, or other appropriate fluid. In other embodiments, the fluid source 716 may be, for example, a hospital oxygen supply.

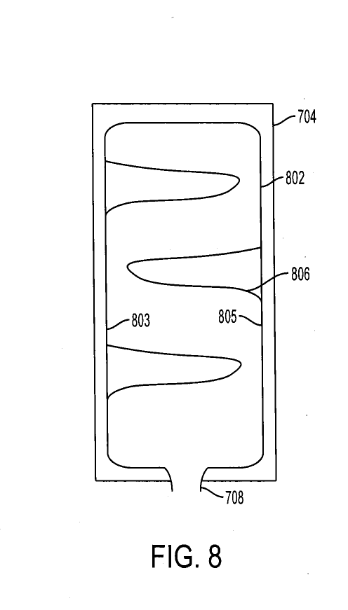

FIG. 8 is a plan view of an interior aspect of a therapy cuff according to an exemplary embodiment. The therapy cuff 704 includes a bladder 802. The bladder 802 is fluidly coupled to the fluid source 716 (shown in FIG. 7) via the conduit 708. At least one weld 806 joins a first surface 803 of the bladder 802 and a second surface 805 of the bladder 802 thereby creating a generally serpentine flow path for compressed fluid. Inflation of the bladder 802 imparts compression to an appendage (not shown) of a patient. The generally serpentine flow path causes a compression gradient to be applied to the appendage of the patient. In a typical embodiment, the therapy cuff 704 is wrapped around a circumference of a bodily appendage of a patient.

Referring to FIGS. 7-8, during operation, the therapy cuff 704 is secured around the appendage. Typically, the therapy cuff 704 is secured about a distal portion of the appendage such as, for example, an ankle or foot region of the patient. The pump 718 compresses fluid from the fluid source 716. The thermal element 714 warms the compressed fluid. The compressed fluid is transmitted to the bladder 802 via the conduit 708. As the bladder 802 fills with compressed fluid, pressure is exerted against the appendage. Additionally, warming of the compressed fluid by the thermal element 714 results in thermal therapy also being applied to the appendage. Application of thermal therapy, particularly application of temperatures higher than the patient's body temperature, causes dilation of blood vessels thereby facilitating movement of accumulated fluid from the appendage. The at least one weld 806 of the bladder 802 prevents the bladder 802 from inflating uniformly and causes a compression gradient to be applied to the appendage. Such gradient compression drives accumulated fluid from the appendage of the patient and is particularly effective in the treatment of, for example, lymphedema. In other embodiments, the thermal element 714 (shown in FIG. 7) may be utilized to cool compressed fluid supplied by the fluid source 716 or contrast thermal therapy may be applied to the patient. In a typical embodiment a frequency, intensity, and duration of compression may be varied by the control unit 702. In addition, a temperature, and duration of thermal therapy may be varied by the control unit 702.

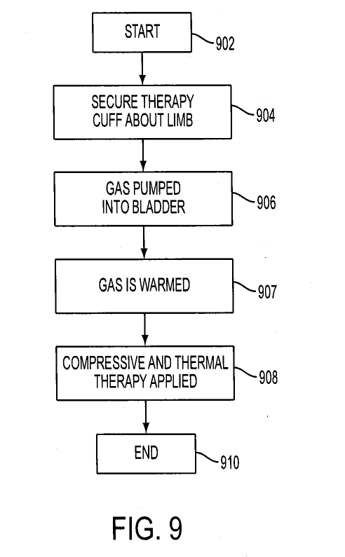

FIG. 9 is a flow diagram illustrating a process for providing treatment utilizing a single fluid for compression and thermal therapy according to an exemplary embodiment. A process 900 begins at step 902. At step 904, the therapy cuff 704 is secured about the appendage (not shown). At step 906, the control unit 702 directs the pump 718 to pump a fluid supplied by the fluid source 716 through the conduit 708 into the bladder 802. At step 907, the control unit 702 directs the thermal element 714 to warm the compressed fluid. At step 908, compressive therapy and thermal therapy is applied to the appendage of the patient. The process 900 ends at step 910.

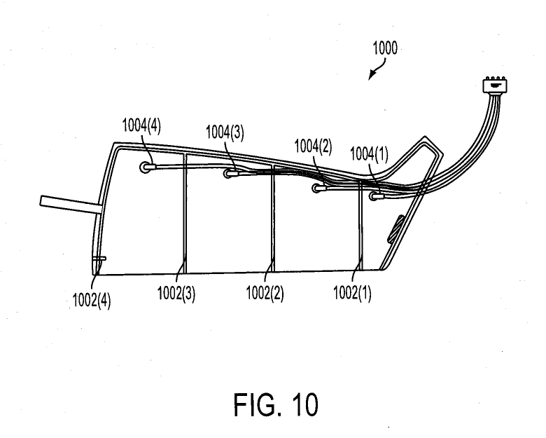

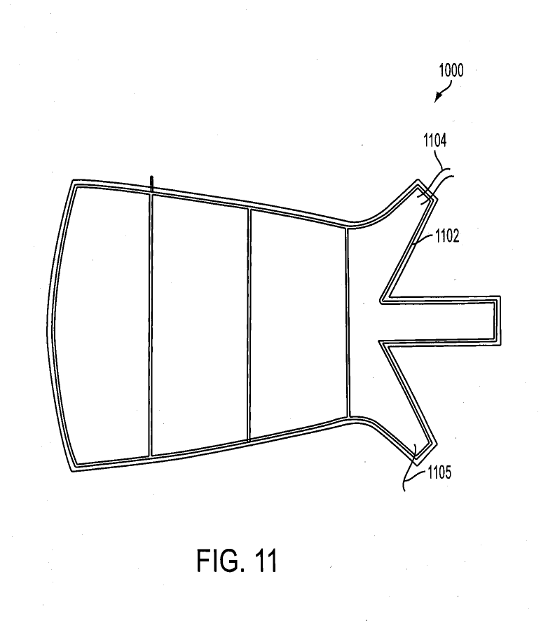

FIG. 10 is a side view of a therapy cuff according to an exemplary embodiment. FIG. 11 is a plan view of an interior portion of the therapy cuff of FIG. 10 according to an exemplary embodiment. Referring to FIGS. 10-11, a therapy cuff 1000 includes a thermal bladder 1102 and compression bladders 1002(1)-1002(4). The therapy cuff 1000 is depicted by way of example in FIG. 10 as including the compression bladders 1002(1)-1002(4); however, one skilled in the art will recognize that therapy cuffs utilizing principles of the invention may include any number of compression bladders. The compression bladder 1002(1) is fluidly coupled to a compression-fluid source such as, for example, the compression-fluid source 116 via a conduit 1004(1). The compression bladder 1002(2) is fluidly coupled to a compression-fluid source such as, for example, the compression-fluid source 116 via a conduit 1004(2). The compression bladder 1002(3) is fluidly coupled to a compression-fluid source such as, for example, the compression-fluid source 116 via a conduit 1004(3). The compression bladder 1002(4) is fluidly coupled to a compression-fluid source such as, for example, the compression-fluid source 116 via a conduit 1004(4). The conduits 1004(1)-1004(4) allow the compression bladders 1002(1)-1002(4) to be pressurized independently of each other. This arrangement is termed “segmental compression”.

Still referring to FIGS. 10-11, in a typical embodiment, the thermal bladder 1102 lines an interior face of the therapy cuff 1000. A first thermal fluid conduit 1104 and a second thermal fluid conduit 1105 fluidly couple the thermal bladder 1102 with a thermal fluid reservoir such as, for example, the thermal fluid reservoir 110 (shown in FIG. 1A). A plurality of welds (not explicitly shown) join two opposing faces of the thermal bladder 1102 thereby causing thermal fluid to be distributed evenly throughout the thermal bladder 1102. In various other embodiments, a resistive heating element may be embedded into the therapy cuff 1000. In such embodiments, the thermal bladder 1102 may be omitted. In still other embodiments, the thermal bladder 1102 may be omitted and the compression fluid may be used as both a compression fluid and a thermal fluid.

Although various embodiments of the method and system of the present invention have been illustrated in the accompanying Drawings and described in the foregoing Specification, it will be understood that the invention is not limited to the embodiments disclosed, but is capable of numerous rearrangements, modifications, and substitutions without departing from the spirit and scope of the invention as set forth herein. It is intended that the Specification and examples be considered as illustrative only.

What is claimed is:

1. A therapy system comprising:
a control unit;
a therapy cuff constructed to be wrapped around an appendage of a patient, the therapy cuff comprising:
a resistive-heating element electrically coupled to the control unit;
at least one compression bladder fluidly coupled to the control unit via a tube, the compression bladder being disposed outwardly of the resistive-heating element;
at least one compression chamber formed in the compression bladder; and
wherein the resistive-heating element dilates a plurality of vessels within the appendage facilitating removal of accumulated fluid from the appendage via inflation of the compression bladder.

2. The therapy system of claim 1, wherein:
the first compression chamber is fluidly coupled to a second compression chamber; and
the second compression chamber is fluidly coupled to a third compression chamber.

3. The therapy system of claim 2, wherein:
the second compression chamber begins to inflate after the first compression chamber; and
the third compression chamber begins to inflate after the second compression chamber.

4. The therapy system of claim 3, wherein inflation of the first compression chamber, the second compression chamber, and the third compression chamber delivers a compression gradient to the appendage of the patient.

5. The therapy system of claim 1, wherein:
the first compression chamber, the second compression chamber, and a third compression chamber are fluidly coupled to the control unit independent of each other;
the first compression chamber is inflated to a first pressure;
the second compression chamber is inflated to a second pressure; and
the third compression chamber is inflated to a third pressure.

6. The therapy system of claim 5, wherein the first pressure, the second pressure, and the third pressure are not equal.

7. A therapy system comprising:
a control unit;
a therapy cuff constructed to be wrapped around an appendage of a patient, the therapy cuff comprising:
a thermal element coupled to the control unit;
a compression bladder disposed outwardly of the thermal element;
a first compression chamber formed in the compression bladder;
a second compression chamber formed in the compression bladder adjacent to the first compression chamber;
a third compression chamber formed in the compression bladder adjacent to the second compression chamber;
a first tube fluidly coupling the first compression chamber to the control unit;
a second tube fluidly coupling the second compression chamber to the control unit;
a third tube fluidly coupling the third compression chamber to the control unit;
wherein inflation of the first compression chamber, the second compression chamber, and the third compression chamber applies a compression gradient to the appendage; and
wherein the thermal element dilates a plurality of vessels within the appendage facilitating removal of accumulated fluid from the appendage via inflation of the compression bladder.

8. The therapy system of claim 7, wherein the thermal element comprises:
a thermal bladder constructed for receipt of a thermal fluid from the control unit;
a fourth tube fluidly coupling the thermal bladder to the control unit;
a fifth tube fluidly coupling the thermal bladder to the control unit; and
wherein, the thermal fluid is warmed in the control unit, transmitted to the thermal bladder via the fourth tube, and returned to the control unit via the fifth tube.

9. The therapy system of claim 8, wherein the thermal bladder comprises a plurality of welds disposed therein, the plurality of welds defining a serpentine flow path for the thermal fluid.

10. The therapy system of claim 7, wherein the thermal element is a resistive-heating element electrically coupled to the control unit.

11. The therapy system of claim 7, wherein:
the first compression chamber is inflated to a first pressure;
the second compression chamber is inflated to a second pressure; and
the third compression chamber is inflated to a third pressure.

12. The therapy system of claim 11, wherein the first pressure, the second pressure, and the third pressure are not equal.

13. A method of treatment, the method comprising:
securing a therapy cuff about an appendage of a patient;
applying thermal therapy to the appendage;
dilating, via the thermal therapy, at least one vessel within the appendage;
inflating a compression bladder within the therapy cuff with a compressed fluid, the compression bladder comprising at least one first compression chamber; and
wherein the dilating facilitates removal of accumulated fluid from the appendage.

14. The method of claim 13, wherein said applying thermal therapy comprises circulating a heat transfer fluid through a thermal-fluid bladder disposed inwardly of the compression bladder.

15. The method of claim 13, wherein said applying thermal therapy comprises utilizing a resistive-heating element.

16. The therapy system of claim 13, wherein:
the first compression chamber is fluidly coupled to the second compression chamber; and
the second compression chamber is fluidly coupled to the third compression chamber.

17. The therapy system of claim 16, wherein:
the second compression chamber begins to inflate after the first compression chamber; and
the third compression chamber begins to inflate after the second compression chamber.

18. The therapy system of claim 17, wherein inflation of the first compression chamber, the second compression chamber, and the third compression chamber delivers a compression gradient to the appendage of the patient.

19. The therapy system of claim 13, wherein:
the first compression chamber, the second compression chamber, and the third compression chamber are fluidly coupled to a control unit independent of each other;
the first compression chamber is inflated to a first pressure;
the second compression chamber is inflated to a second pressure; and
the third compression chamber is inflated to a third pressure.

20. The therapy system of claim 19, wherein the first pressure, the second pressure, and the third pressure are not equal.
